(19) United States
(12) Patent Application Publication
(10) Pub. No.: US 2025/0200289 A1
(43) Pub. Date: Jun. 19, 2025

(54) REAL-TIME GUIDANCE AND REPORTING FOR CUSTOMER INTERACTION

(71) Applicant: Allstate Insurance Company, Northbrook, IL (US)

(72) Inventors: Olivia Mahler-Haug, Northbrook, IL (US); Isabella DeRosa, Northbrook, IL (US); Corey Fyock, Northbrook, IL (US); Adam Hale, Belfast (IE)

(73) Assignee: Allstate Insurance Company, Northbrook, IL (US)

(21) Appl. No.: 18/977,145

(22) Filed: Dec. 11, 2024

Related U.S. Application Data
(60) Provisional application No. 63/609,692, filed on Dec. 13, 2023.

(51) Int. Cl. G06F 40/35; H04N 21/478

(52) U.S. Cl. CPC G06F 40/35; H04N 21/478

(57) ABSTRACT

An agent interaction apparatus, systems, and methods include obtaining streaming interaction data contemporaneously generated from an interaction with a user; determining, with a large language model, an intent expressed in the streaming interaction data; generating a prompt comprising one or more inquiries based on the intent expressed in the streaming interaction data; generating, from the streaming interaction data fed into the large language model and directed by the prompt, text corresponding to one or more responses from the user to the one or more inquiries; generating, with the large language model, at least one guidance request based on an absence of a response to, a need for clarification of, or supplemental information to request for at least one of the one or more inquiries based on the one or more responses from the user; and outputting the at least one guidance request within a guidance section of an interface.

### CROSS-REFERENCE TO RELATED APPLICATIONS

The present application claims the benefit of U.S. Provisional Patent Application No. 63/609,692 filed on Dec. 13, 2023, the entirety of which is incorporated by reference herein.

### TECHNICAL FIELD

The present disclosure relates to techniques for real-time guidance and reporting during agent-customer interactions and, more particularly, for an artificial intelligent (AI) model receiving combinations of audio and other multimedia information in real-time to conduct a real-time analysis to generate a guidance request such as to identify conflict(s) regarding the interaction and providing automated guidance to an agent interacting with a customer regarding further questioning based on the generated guidance request.

### BACKGROUND

Customer support services typically consist of human-operated contact centers and automated response systems, such as chatbots that correspond with individuals such as customers via voice call, video call, email, or chat. Representatives, whether humans or chatbot systems, engage with a customer to assist with their reason for calling. A representative may correspond with the customer to obtain information needed to help with the customer's situation. For example, the information obtained from the customer may be used to complete a report, an application, or the like. For a representative to make sure they obtain all the information they need and resolve any potential conflicts, many hours of training and close attention to detail may be involved when engaging with a customer.

Accordingly, there is a need to improve processes for obtaining and processing information from an individual during a communication with the representative.

### SUMMARY

According to the subject matter of the present disclosure, an agent interaction apparatus, includes: one or more memories; and one or more processors coupled to the one or more memories storing computer-executable instructions configured to cause the agent interaction apparatus to: obtain streaming interaction data contemporaneously generated from an interaction with a user; determine, with a large language model, an intent expressed in the streaming interaction data; generate a prompt comprising one or more inquiries based on the intent expressed in the streaming interaction data; generate, from the streaming interaction data fed into the large language model and directed by the prompt, text corresponding to one or more responses from the user to the one or more inquiries; generate, with the large language model, at least one guidance request based on an absence of a response to, a need for clarification of, or supplemental information to request for at least one of the one or more inquiries based on the one or more responses from the user; and output the at least one guidance request within a guidance section of an interface communicatively coupled to the agent interaction apparatus.

According to the subject matter of the present disclosure, an agent interaction method includes obtaining streaming interaction data contemporaneously generated from an interaction with a user; determining, with a large language model, an intent expressed in the streaming interaction data; generating a prompt comprising one or more inquiries based on the intent expressed in the streaming interaction data; generating, from the streaming interaction data fed into the large language model and directed by the prompt, text corresponding to one or more responses from the user to the one or more inquiries; generating, with the large language model, at least one guidance request based on an absence of a response to, a need for clarification of, or supplemental information to request for at least one of the one or more inquiries based on the one or more responses from the user; and outputting the at least one guidance request within a guidance section of an interface communicatively coupled to an agent interaction apparatus.

According to the subject matter of the present disclosure, an agent interaction apparatus, comprises: one or more memories; and one or more processors coupled to the one or more memories storing computer-executable instructions configured to cause the agent interaction apparatus to: obtain streaming interaction data contemporaneously generated from an interaction with a user; determine, with a large language model, an intent expressed in the streaming interaction data; generate a prompt comprising one or more inquiries based on the intent expressed in the streaming interaction data; generate, from the streaming interaction data fed into the large language model and directed by the prompt, text corresponding to one or more responses from the user to the one or more inquiries; generate, with the large language model, at least one guidance request based on an absence of a response to, a need for clarification of, or supplemental information to request for at least one of the one or more inquiries based on the one or more responses from the user; output the at least one guidance request within a guidance section of an interface communicatively coupled to the agent interaction apparatus; based on the at least one guidance request, send a request to the user to provide one or more multimedia data uploads related to the intent expressed in the streaming interaction data; and obtain the one or more multimedia data uploads based on the request.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a first portion of an illustrative agent interaction console, accordingly to one or more embodiments as shown and described herein.

FIG. 2 schematically depicts a second portion of the illustrative agent interaction console.

FIG. 3 schematically depicts an action corresponding to the guidance section of the illustrative agent interaction console.

FIG. 4 schematically depicts a third portion of the illustrative agent interaction console.

FIG. 5 schematically depicts an illustrative signal flow diagram corresponding to the agent interaction console of FIGS. 1-4.

FIG. 6 depicts an illustrative flowchart of an agent interaction apparatus implemented method, according to one or more embodiments shown and described herein

FIG. 7 schematically and structurally depicts a system with communicatively coupled system components for implementing the agent interaction console of FIGS. 1-4 and/or the agent interaction processes of FIGS. 5-6, according to one or more embodiments shown and described herein.

### DETAILED DESCRIPTION

Embodiments of the present disclosure relate to systems, methods, and computer implemented programs providing real-time guidance and reporting for customer interactions and, more particularly, for an Al model receiving combinations of audio and other multimedia information in real-time to conduct a real-time analysis to identify conflict(s) regarding the interaction and providing automated guidance to an agent interacting with a customer regarding further questioning based on the identified conflict(s). Customer call centers receive calls and/or other forms of communication from customers seeking assistance on a product or service. For example, customer call centers may handle technical support for products, changes to service plans, billing inquires and processing, reports regarding an insurance claim, or the other matters. Agents receiving a call at a call center seek to collect information and help address a customer's inquiry.

Embodiments described herein provide technical solutions for assisting agents with obtaining information that is needed to respond to the customer's inquiry through an agent interaction console configured to guide an agent through an interaction, process multimedia information, identify conflicts, and generate a report and/or resolution and/or provide information based on the analysis downstream to one or more other technical tools to aid in processing the inquiry for the customer. Aspects of the embodiments may continue to function following the agent-customer interaction when updates or follow-ups are needed. The technical solutions described herein provide the technical benefits of improving information collection, conflict resolution, and further processing of an issue, such as reporting and efficient and automated processing of an insurance claim of a customer.

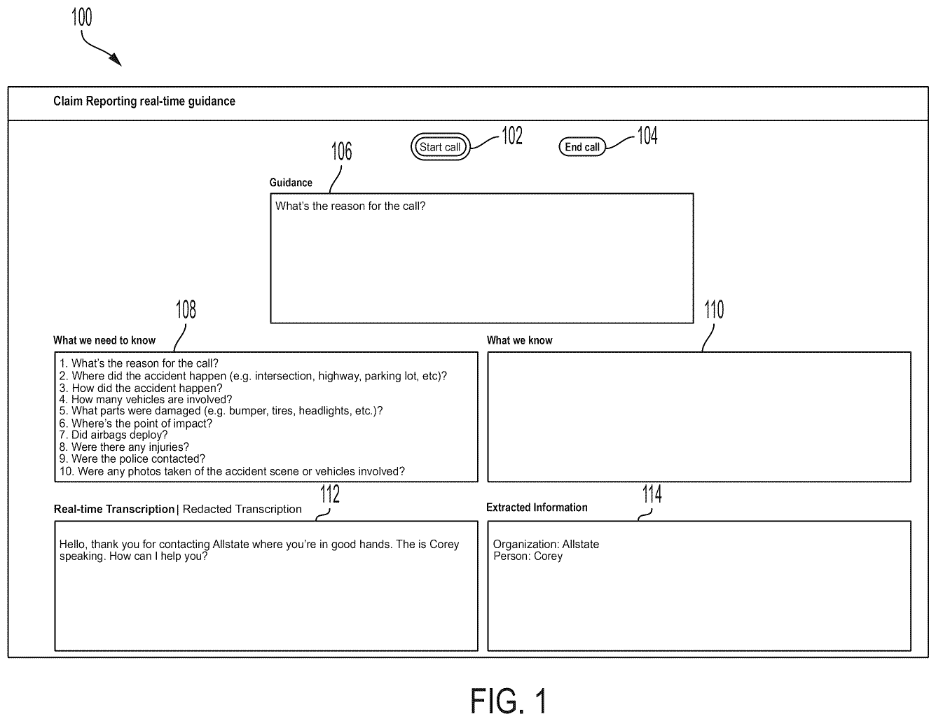

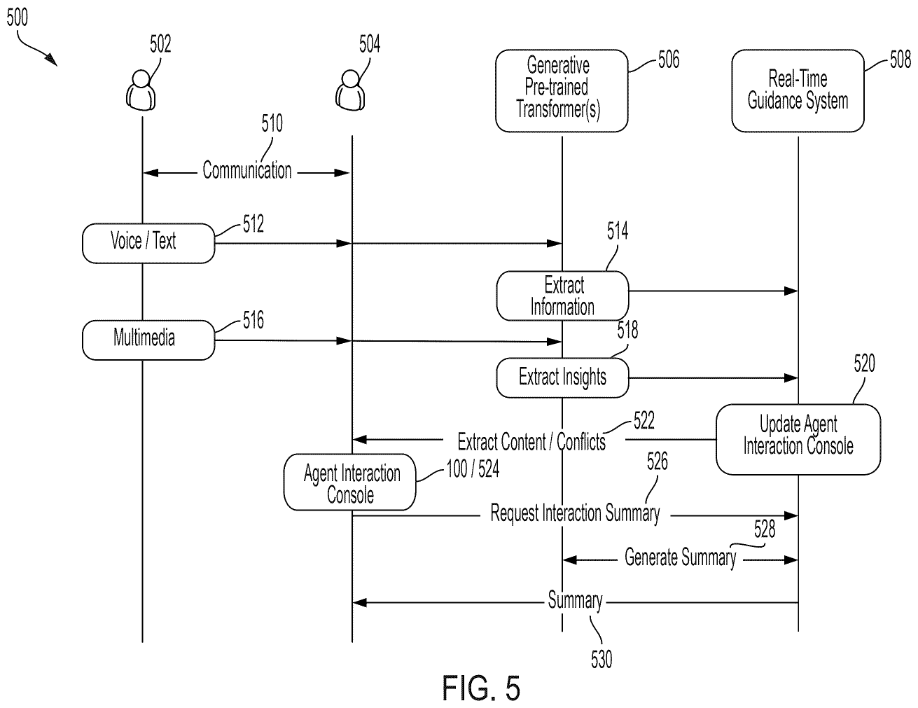

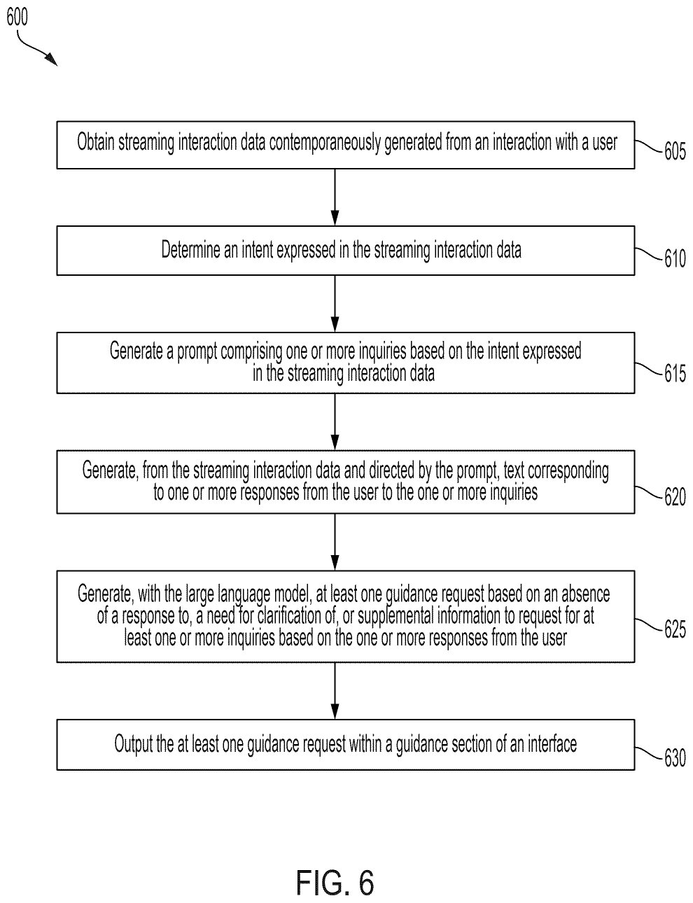

Aspects of the present disclosure will now be described with reference to FIGS. 1-4 that depict features of an agent interaction console, FIG. 5 that depicts an example signal flow diagram, FIG. 6 that depict agent interaction flowcharts for systems and methods as described herein and FIG. depicts an agent interaction system and apparatus as described herein.

FIG. 1 depicts a first portion of an illustrative agent interaction console 100. When a customer, such as of an insurance company, contacts a call center via voice communication, chat, or other live interaction method, the interaction request is routed to an agent, such as for the insurance company. Aspects of the present disclosure are described with reference to a voice based interaction (e.g., a call) between a customer and an agent, but it should be understood that present disclosure is not limited to calls and may incorporate other media such as chats, email, and other suitable media streams.

When an agent connects with a customer, the agent interaction console 100 is automatically triggered to activate in response to connecting with the customer. In some embodiments, the agent interaction console 100 may include call operation options selectable by the agent such as start call 102, end call 104, and options the agent can select to manage the call, such as call forwarding to another agent or the like.

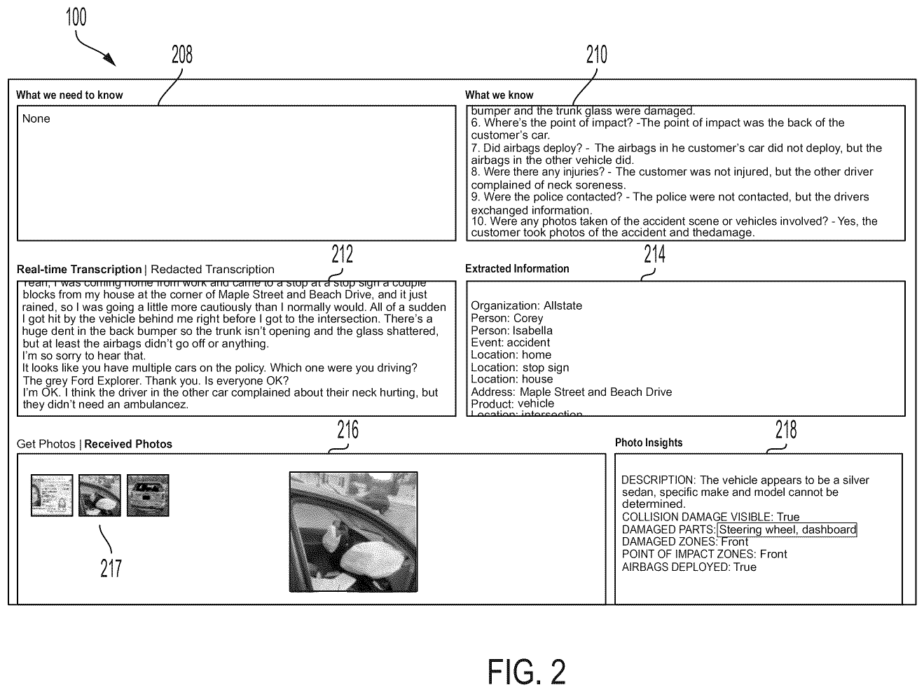

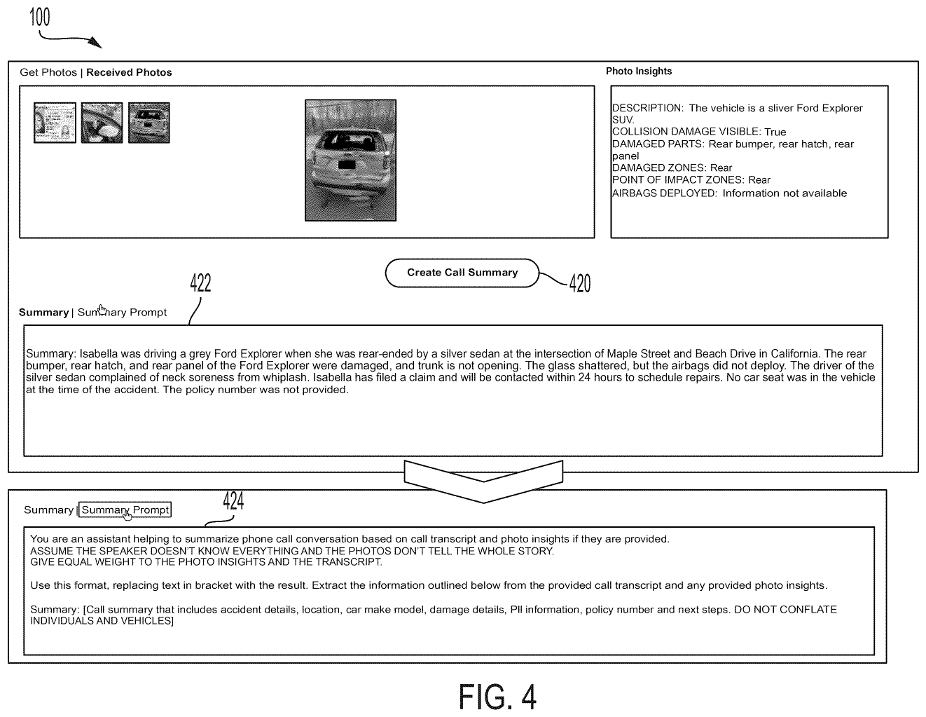

In response to a call starting, the AI model implemented by the agent interaction console 100 is initiated. As described in greater detail further below, the AI model may be configured to operate with the agent interaction console 100 to obtain streaming interaction data contemporaneously generated from an interaction with a user, determine an intent expressed in the streaming interaction data; generate a prompt comprising one or more inquiries based on the intent expressed in the streaming interaction data, and generate, from the streaming interaction data fed in and directed by the prompt, text corresponding to one or more responses from the user to the one or more inquiries. A graphical user interface (GUI) of the agent interaction console 100 includes multiple sections, for example, including but not limited to a guidance section 106, a “what we need to know” section 108, a “what we know” section 110, a real-time transcription section 112 (that may include redacted transcription capabilities), an extracted information section 114, a multimedia section 216 (FIG. 2), a multimedia insights section 218 (FIG. 2), a create call summary option 420 (FIG. 4), and a summary section 422 (FIG. 4).

Initiation of the agent interaction console 100, one or more of the sections are populated with initial query questions and/or prompts. For example, the guidance section 106, may be initialized with a query to guide the agent in starting the conversation. The guidance section 106 may provide specific language for the agent to communicate to the customer. Alternatively, the guidance section 106 may provide an indication to the agent as to what needs to be achieved such as determining “What's the reason for the call?” The agent proceeds to communicate with the customer to fulfill the initial guidance.

Each communication made by the agent to the customer and the customer to the agent is processed by one or more generative pre-trained transformers 506 (FIG. 5). For example, the one or more generative pre-trained transformers 506 process the voice (or other types of communication) and generate a text-based transcript in real-time, which is populated in the real-time transcription section 112 (FIG. 1).

In some instances, when a customer calls the customer call center, they may follow some initial prompts which indicate the reason for their call. In response, the “what we need to know” section 108 of the agent interaction console 100 may be prepopulated with information that is needed based on the reason for the call. The needed information may be based on a set of predefined information corresponding to specific topics. Alternatively, the needed information may be populated once the customer's response to the agent expresses the purpose of the call.

With the “what we need to know” section 108 populated, for example, as shown in FIG. 1, the agent proceeds to converse with the customer to obtain information outline in the “what we need to know” section 108. As previously discussed, as the agent and customer converse, the conversation is processed by the one or more generative pre-trained transformers 506 to generate the text-based transcript in real-time, which is populated in the real-time transcription section 112.

Turning to FIG. 2, the one or more generative pre-trained transformers 506, large language model, and/or other machine-learning models extract information expressed in the interactions between the agent and customer that responds to or corresponds to information needed in the “what we need to know” section 108. The systems described herein may be communicatively coupled to and utilize artificial intelligence (AI) such as small language models, large language models (LLMs), transformer models, and/or other generative AI models. LLMs are a type of artificial intelligence model that have been trained through deep learning algorithms to recognize, generate, translate, and/or summarize vast quantities of written human language and textual data. LLMs are a type of generative AI, which is a type of artificial intelligence that uses unstructured deep learning models to produce content based on user input. LLMs are considered a specific application of natural language processing that utilize advanced AI algorithms and technologies to generate believable human text an complete other text-based tasks. Examples of LLMs include OpenAI's ChatGPT, Nvidia's NeMO™ LLM, Meta's LLaMa, and Google's BERT.

The extracted information is populated in the “what we know” section 210 as shown in FIG. 2 of the agent interaction console 100 and the corresponding prompt in the “what we need to know” section 208 as shown in FIG. 2 is removed upon receipt of the information. More specifically, the question, for example, “Where did the accident happen?” prompted in the “what we need to know” section 108 is moved, upon receipt of an answer by the customer to the inquiry by the agent, to the “what we know” section 210, and the response to the prompt or question by the customer is populated therein. The question and answer may be conducted via a recorded audio conversation that is converted into a text transcript based on national language processing (NLP) and/or other AI based systems managed by the one or more generative pre-trained transformers 506, large language model, and/or other machine-learning models, such as ChatGPT.

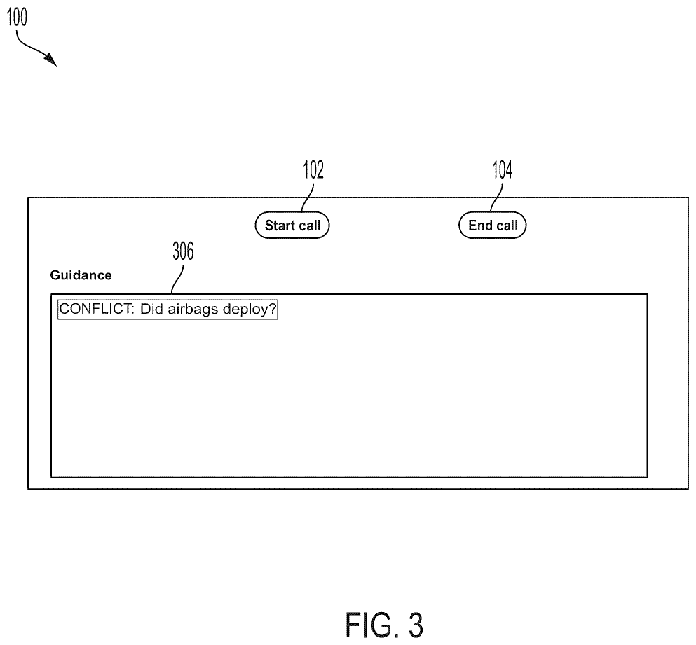

The AI model may further operate with the agent interaction console 100 to generate at least one guidance request based on an absence of a response to, a need for clarification of, or supplemental information to request for at least one of the one or more inquiries based on the one or more responses from the user, and output the at least one guidance request within a guidance section of an interface communicatively coupled to the agent interaction apparatus. For example, in response to the question “Did airbags deploy?”, the customer may have answered “No,” but then the multimedia section shows photos uploaded (e.g., as multimedia data uploads of the multimedia section 216 of FIG. 2) by the customer of a vehicle with deployed airbags (e.g., as multimedia data insights of the multimedia insights section 218 of FIG. 2). The guidance section 106 may then note a conflict 306 (FIG. 3, “Did airbags deploy?”) for the agent to inquire about to the customer because the multimedia data insight indicating that an airbag deployed conflicts with the customer's response of “No” to the inquiry of “Did airbags deploy?” obtained through the interaction with the agent. The customer may clarify (i.e., the airbags did not deploy in the customer's car but did in the other vehicle involved in the collision), and the clarified may be recorded as a response, such as the recorded response in FIG. 2 (e.g., within a “what we know” section 210 under response number 7) is “The airbags in the customer's car did not deploy, but the airbags in the other vehicle did.”

Additionally, other extracted information that may not specifically relate to a prompt of information needed corresponding to a specific reason for a customer's call is provided in an outline in the extracted information section 214 (e.g., the extracted information section 114). For example, when organization names, persons, events, locations, products, and the like are detected in the conversation by the one or more generative pre-trained transformers 506, large language model, and/or other machine-learning models, that information is extracted and populated in real-time into the extracted information section 214.

During the interaction with the customer, the agent may send an upload link to the customer so that the customer can provide multimedia data such as photos, documents, videos, text such as via a chat system, or the like. The upload link may be sent via a text message, an email, an application based notification, or the like to the customer. The upload link provides the customer with access to an upload portal for providing the multimedia information. In some instances, the customer may not have the multimedia ready to provide during the call. Accordingly, the upload link may continue to remain active following the end of the agent-customer interaction. In embodiments, the AI model may collect information in real-time and additionally at a later time (i.e., the customer can upload photos to the upload link after the interaction with the agent, and the AI model may analyze such as to identify conflicts and/or provide insights based on the upload when receiving the information to communication to the analysis to further process the claim and/or resolve a conflict).

Multimedia information provided by the customer via the upload portal is processed by the one or more generative pre-trained transformers 506, large language model, and/or other machine-learning models. For example, multimedia information such as photos may be processed by an image processing and/or computer vision machine learning model, such as ImageGPT (iGPT). The model can identify and extract insights from the one or more photos. For example, insights may include document type, information from the documents, videos, or photos, such as name, address, and the like from an image of a driver's license or insurance card, including height, weight, sex, location, organ donation status, and the like. The system may be able to determine a potential location of the accident and inquire accordingly based on a license of the customer, such as inquiring whether the accident took place in California based on an analyzed California driver's license. Other business rules such as specific to a jurisdiction may be asked by the agent based on the analysis, such as if the accident occurred in California, whether a child's set was installed in the vehicle. Optical character recognition (OCR) may be applied to the documents. As a further example, the insights may include vehicle information, such as make, model, color, location of damage, state of the vehicle (e.g., air bags deployed), or the like. The insights are populated into the insights section 218 of the agent interaction console 100.

In addition to extracting insights, the agent interaction console 100 may compare insights in the insights section 218 to the information in the extracted information section 214 and the “what we know” section 210 to determine whether there are any conflicts. When a conflict is detected, the agent interaction console 100 provides guidance regarding the conflict 306 as depicted in FIG. 3. This alerts the agent to the presence of a conflict which they can then address with the customer for clarification.

As noted above, when the agent and customer have concluded their interaction, the agent may generate a call summary. Turning to FIG. 4, call summary generation aspects of the agent interaction console 100 are depicted. Upon conclusion of the agent-customer interaction, the agent may select the “Create Call Summary” option 420 which causes the one or more generative pre-trained transformers 506, large language model, and/or other machine-learning models to generate a call summary and populating the call summary section 422 with the same. The call summary provides a narrative form summary of the agent-customer interaction. The call summary is generated in response to a prompt defined in the summary prompt section 424. The call summary and other extracted information may be sent to other technical tools aiding in processing the claim as a record of the interaction and/or may be used to aid in scheduling a follow-up conversation or communication between the agent and the customer (i.e., call the customer back within 48 hours to determine if the customer was contacted within the 24 hour period stated to the customer). In embodiments, classified extracted information from the transcript and/or multimedia information may be sent downstream to other technical tools, such as a photo of a hospital bill to go to a causalities section of the insurance agency for processing and/or a photo or text information regarding damaged parts of the vehicle to be sent to a system utilized by an adjuster for further processing.

Turning to FIG. 5, an illustrative signal flow diagram 500 corresponding to the agent interaction console 100 is depicted. The signal flow diagram 500 corresponds to the previously described agent-customer interaction utilizing the agent interaction console 100. For example, the customer 502 and the agent 504 communication 510 via a call, chat, or other communication interface. Communication 510 between the customer 502 and the agent 504 include voice/text 512 and/or multimedia 516. Customer voice/text 512 communication is received by the agent 504 and the one or more generative pre-trained transformers 506, large language model, and/or other machine-learning models. Similarly, multimedia 516 from the customer is received by the agent 504 and the one or more generative pre-trained transformers 506, large language model, and/or other machine-learning models. The one or more generative pre-trained transformers 506, large language model, and/or other machine-learning models may be a generative artificial intelligence system, such as chatGPT, imageGPT, language model for dialogue applications (LaMDA), LLAMA, BLOOM or the like.

The one or more generative pre-trained transformers 506 is configured to extract information 514 from voice/text 512 and extract insights 518 from multimedia 516 which is provided to real-time guidance system 508. The real-time guidance system 508 updates the agent interaction console 100 at block 522 and transmits the extracted content and/or conflicts to the agent 504 via the agent facing portion of the agent interaction console 524 (e.g., the agent interaction console 100 described with reference to FIGS. 1-4).

As described herein, in response to the agent selecting the “Create Call Summary” option 420, a request for an interaction summary 526 is transmitted to the real-time guidance system 508. The real-time guidance system 508 causes the one or more generative pre-trained transformers 506 to generate a call summary 528. The call summary 530 that is generated is sent to the agent 504 via the agent facing portion of the agent interaction console 524 (e.g., the agent interaction console 100 described with reference to FIGS. 1-4).

Features of the present disclosure may be provided by one or more computing devices having one or more processors and one or more memories configured to implement aspects described herein. The agent interaction console 100 can be provided to a display device on an agent's computing device.

### Example Operations

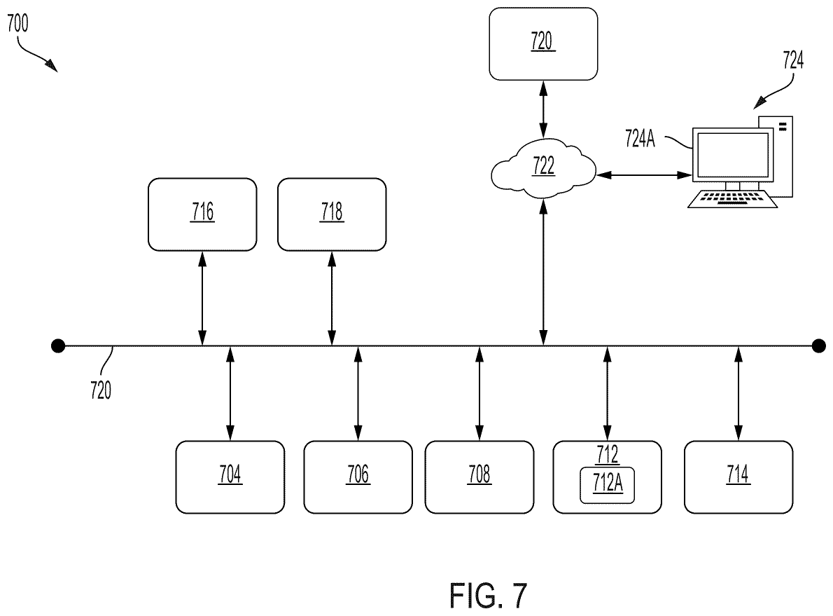

FIG. 6 shows a process 600 as an example agent interaction method, optionally implemented by and/or through the agent interaction consoles 100 of FIGS. 1-4 and/or the agent interaction apparatus 700 (or system) of FIG. 7 described in greater detail further below. The agent interaction apparatus 700 may include one or more memories and one or more processors coupled to the one or more memories storing computer-executable instructions configured to cause the agent interaction apparatus to perform the control schemes described herein, such as the process 600 described below.

At block 605, an agent interaction apparatus may obtain streaming interaction data contemporaneously generated from an interaction with a user. For example, the interaction data may be voice/text 512 and/or multimedia 516 received through input/output hardware of a computing device, as discussed with reference to at least FIGS. 5 and 7. The interaction data may be a transcription of voice or text information from a customer and agent interaction. The transcription may be generated based off audio data receive and/or transmitted through the input/output hardware contemporaneously (e.g., in real-time or near real-time) during the agent-customer interaction. The interaction data may be streaming interaction data. In some aspects, the streaming interaction data is populated in the real-time transcription section 112 as discussed with reference to FIG. 1.

At block 610, using a large language communicatively coupled to the agent interaction apparatus, an intent expressed in the streaming interaction data is determined. The large language model may be prompted to determine the intent being expressed in the streaming interaction data. The intent may refer to the reason a customer is engaging with an agent. For example, the customer may have been involved in an accident and needs to file a claim. As another example, the customer's vehicle may have broken down and the customer requires roadside assistance, but in order for assistance to be provided additional information from the customer may be needed to provide the required roadside assistance. The intent may be returned to the agent through the guidance section 106 of the agent interaction console 100 as discussed with reference to FIG. 1. If no intent has been determined by the large language model, the guidance section 106 may indicate to the agent a question, such as “What's the reason for the call?” which may guide the agent to redirect the conversation with the customer to obtain the intent of the call before proceeding further with the interaction. Once an intent is determined, further guidance may be developed and provided to the agent to efficiently engage with the customer in order to obtain the information needed to address the intent (e.g., the issue or request) that the customer is contacting the agent regarding.

At block 615, the agent interaction apparatus may be configured to generate a prompt comprising one or more inquiries based on the intent expressed in the streaming interaction data. The prompt may include a plurality of prompts that are generated or extracted from a library of prompts based on the intent. For example, an intent of completing a claim report for a vehicle accident may include a plurality of prompts for the large language model to address and respond to as the streaming interaction data is fed into the large language model. For example, one or more of the prompts that are generated at block 615 may include inquiries corresponding to questions such as how, when, where, what, how long, who or what was involved, whether any multimedia is available, and/or the like. The prompts may correspond to one or more inquires relating to what information is needed to assist with handling the intent expressed by the customer.

At block 620, the large language model may continuously receive streaming interaction data from the interaction between the agent and the customer. In some instances, the interaction data may include multimedia information such as a video, a photo, a fillable form, or other non-text or audio based data type. At block 620, and from the streaming interaction data fed into the large language model (of block 605) and directed by the prompt (of blocks 610, 615), text may be generated corresponding to one or more responses from the user to the one or more inquiries (of block 615). As a non-limiting example, the large language model, as directed by the one or more prompts generated at block 615, generates text corresponding to the one or more responses of the customer present in the streaming interaction data. The large language model may configured synthesize a plurality of utterances (e.g., segments of streaming interaction data) form the customer into text string responding to the one or more prompts. For example, the customer may engage in a lengthy one-sided narrative discussing the situation or their recount of events of a vehicle accident. The narrative may begin with a general statement of where the event occurred, followed by discussion of what happened, and then return more specific discussion of where the event occurred, for example, including statements of streets and/or addresses describing the area. The large language model may be configured to continuously extract, update, and revise text that is responsive to the one or more prompts as additional streaming interaction data is fed into the large language model. In some aspects, the large language model may further assess whether an update or revision to the text is in conflict with the previous version or an update or revision that includes more detail with respect to the prior text generation. Further to this aspect, it should be understood that the large language model may iteratively process the streaming interaction data along with previously received interaction data and each of the one or more prompts regardless of whether a prompt has been previously addressed (e.g., a text response generated) and output, for example, to the “what we know” section 110 of the agent interaction console 100 as depicted and discussed with reference to FIGS. 1-4. Accordingly, the agent interaction apparatus may be configured to cause the agent interaction console to dynamically update content displayed within each of the one or more sections during the interaction with the user based on at least one of the one or more responses from the user to the one or more inquiries or the user guidance response.

At block 625, with the large language model, at least one guidance request may be generated based on (i) an absence of a response to, (ii) a need for clarification of, or (iii) supplemental information to request for at least one of the one or more inquiries based on the one or more responses from the user (from block 620). The at least one guidance request may be in the form of a question that an agent may directly ask of the customer. In this manner, the at least one guidance may be contextually framed so that the agent does not need to rephrase in order to engage with the customer. In some aspects, the at least one guidance may be a request for additional information on a particular topic, a request for a clarification to a conflict identified by the large language model, or other communication designed to further the conversation with the customer.

At block 630, the at least one guidance (from block 625) may be output within a guidance section of an interface communicatively coupled to the agent interaction apparatus, such as the agent interaction apparatus 700 also referenced as a system described in greater detail further below. For example, the large language model's generated guidance at block 625 may be output as text in the guidance section 106 of the agent interaction console 100 as depicted and described with reference to FIGS. 1-4. In instances where the guidance relates to a conflict identified by the large language model, the guidance may be flagged accordingly. For example, in some aspects the text may be preceded with the recitation “Conflict,” for example, as depicted in FIG. 3. In other aspects, other types of indications may be used. For example, a color, font, icon, or the like may be used to indicate that the at least one guidance is directed to resolving a conflict in information the customer has provided. In some aspects, an alert may be output within the interface contemporaneously with the determination that the one or more conflicts are present. The alert may be generated and provided through the agent interaction console to the agent. In additional or alternative embodiments, a user guidance response may be received based on the at least one guidance request. The at least one guidance request may then be removed from the guidance section of the interface when the user guidance response is determined, by the large language model continuously processing the streaming interaction data, to satisfy the at least one guidance request.

Thus, in some aspects, when a response corresponding to one of the at least one guidance is received and identified by the large language model, the corresponding guidance may be removed from the guidance section 106. For example, the agent interaction apparatus may cause the agent interaction console to remove the at least one guidance request from the guidance section of the interface when the user guidance response is determined, by the large language model that is continuously processing the streaming interaction data, since the at least one guidance request is satisfied. However, at a later time should a conflict arise regarding the previously removed guidance, a new guidance may be generated and presented in the guidance section.

In some embodiments, the process 600, which may be implemented by the agent interaction apparatus 700 as described herein, may include additional processes. For example, in some aspects, based on the at least one guidance request, a request may be sent to the user to provide one or more multimedia data uploads related to the intent expressed in the streaming interaction data. The one or more multimedia data uploads may be obtained based on the request, and, with the large language model, one or more multimedia insights may be generated from the one or more multimedia data uploads. The one or more multimedia insights may be output within the interface communicatively coupled to the agent interaction apparatus 700. The one or more multimedia insights may include identification of what is captured in the multimedia, such as identification of a vehicle, the color of a vehicle, whether a deployed airbag is visible, regions of damage, and/or other information. The multimedia insights may be obtained by one or more artificial intelligence models, such as a large language model that is trained to process multimedia data and output information based on a prompt. The one or more multimedia insights may be output to multimedia section 216 of the agent interaction console 100 as depicted with reference to FIG. 2.

In some aspects, one or more multimedia data uploads may be obtained from the user during the interaction, and with the large language model, one or more multimedia insights may be generated from the one or more multimedia data uploads. With the large language model, the one or more multimedia insights and the one or more responses may be compared to determine that one or more conflicts are present. For example, the one or more responses may state that air bags in the vehicle did not deploy as a result of the accident. However, a multimedia data upload, for example, a photo of the vehicle after the accident, may show deployed air bags. The deployed air bags may by identified through the artificial intelligence models processing of the photo, which when compared to the responses, raises a conflict that needs to be resolved. With the large language model from the one or more conflicts, the at least one guidance request may be generated based on the need for clarification of the at least one of the one or more inquires to resolve the one or more conflicts. The guidance may be output as text in the guidance section 106 of the agent interaction console 100 as depicted and described with reference to FIGS. 1-4. For example, FIG. 1 shows a guidance section 106 noting a conflict 306 (of FIG. 3, “Did airbags deploy?”) when a customer may have previously answered “No” but uploaded multimedia section photos show a vehicle with deployed airbags to provide further clarification to resolve the conflict, which clarification may be record (e.g., such as with respect to the recorded response in FIG. 2 is “The airbags in the customer's car did not deploy, but the airbags in the other vehicle did”).

In some aspects, to generate, with the large language model, the one or more multimedia insights from the one or more multimedia data uploads as described above, the large language model may be directed by the one or more inquiries such that the one or more multimedia insights may be based on at least one of the one or more inquiries. For example, a tailored search for information that is needed to address the reason for the call instead of a very broad application of extracting information without focus from the multimedia may be translated into one or more inquiries. That is, multimedia information can provide hundreds or thousands of insights, but many may not be relevant to the reason for the call.

As discussed in detail herein, the agent interaction console may include a number of difference sections. For example, the one or more sections of the agent interaction console may comprise a respective section for displaying at least one of a real-time transcription of the streaming interaction data, the one or more inquiries, the one or more responses, the at least one guidance request, one or more multimedia data uploads, one or more multimedia insights based on the one or more multimedia data uploads, the user guidance response, or combinations thereof. Thus, an interface as described herein may include one or more sections configured to dynamically update content displayed within each of the one or more sections during the interaction with the user based on at least one of the one or more responses from the user to the one or more inquiries or the user guidance response. The one or more sections may include a respective section for displaying at least one of: a real-time transcription of the streaming interaction data (e.g., real-time transcription sections 112, 212 of FIGS. 1-2), the one or more inquiries (e.g., within a “what we need to know” sections 108, 208 of FIGS. 1-2), the one or more responses (e.g., within a “what we know” sections 110, 210 of FIGS. 1-2), the at least one guidance request (106, 306), one or more multimedia data uploads (e.g., the multimedia section 216 of FIG. 2), one or more multimedia insights (e.g., the multimedia insights section 218) based on the one or more multimedia data uploads (from the multimedia section 216), the user guidance response (e.g., recorded within a “what we know” sections 110, 210 of FIGS. 1-2), or combinations thereof as set forth above.

In some aspects, a request to provide an interaction summary upon conclusion of the interaction with the user may be received based on at least the one or more responses from the user to the one or more inquiries and the user guidance response. For example, the interaction summary may be initiated by an agent selecting a “create call summary” option 420 within the agent interaction console 100 as depicted in FIG. 1. One or more large language models, prompted by a summary prompt (e.g., 424, FIG. 4), may be implemented by the agent interaction apparatus to generate the interaction summary. Thus, with the large language model directed by a summary prompt, the interaction summary may be generated and output within a summary section of the interface communicatively coupled to the agent interaction apparatus 700.

In one aspect, process 600, or any aspect related to it, may be performed by an apparatus, such the agent interaction apparatus 700 (or system) of FIG. 6, which includes various components operable, configured, or adapted to perform the process 600. The agent interaction apparatus 700 (or system) is described below in further detail.

Note that FIG. 6 is just one example of a method, and other methods including fewer, additional, or alternative operations are possible consistent with this disclosure.

### Example System

Referring now to FIG. 7, an embodiment of the agent interaction apparatus 700 (also referred to herein as the system 700) as described herein includes a communication path 702, one or more processors 704, a memory component 706 comprising one or more memories, an artificial intelligence module 712, a machine learning sub-module 712A of the artificial intelligence module 712, one or more databases 714, an interaction module 716, a network interface hardware 718, a network 722, a server 720, a device 724, such as a computing device, and a user interface 724A for display on the device. The various components of the system 700 and the interaction thereof will be described in detail below. In embodiments herein, the system 700 comprises a memory as the memory component 706 storing computer-executable instructions that, when executed by a processor 704, cause the system to one or more logical processes as described herein, and/or methods are configured to implement one or more logical processes as described herein (such as process 600 of FIG. 6 and/or the process flow depicted and described with reference to the flow diagram 500 of FIG. 5).

While only one server 720 and one device 724 is illustrated in FIG. 7, the system 700 can comprise multiple servers containing one or more applications and/or computing devices. In some embodiments, the system 700 is implemented using a wide area network (WAN) or network 722, such as an intranet or the internet. The device 724 may include digital systems and other devices permitting connection to and navigation of the network 722. It is contemplated and within the scope of this disclosure that the device 724 may be a personal computer, a laptop device, a smart mobile device such as a smart phone or smart pad, or the like. Other system 700 variations allowing for communication between various geographically diverse components are possible. The lines depicted in FIG. 7 indicate communication rather than physical connections between the various components.

The system 700 comprises the communication path 702. The communication path 702 may be formed from any medium that is capable of transmitting a signal such as, for example, conductive wires, conductive traces, optical waveguides, or the like, or from a combination of mediums capable of transmitting signals. The communication path 702 communicatively couples the various components of the system 700. As used herein, the term “communicatively coupled” means that coupled components are capable of exchanging data signals with one another such as, for example, electrical signals via conductive medium, electromagnetic signals via air, optical signals via optical waveguides, and the like.

The system 700 of FIG. 7 also comprises the one or more processors 704. Each processor 704 can be any device capable of executing machine-readable instructions. Accordingly, each processor 704 may be a controller, an integrated circuit, a microchip, a computer, or any other computing device. Each processor 704 is communicatively coupled to the other components of the system 700 by the communication path 702. Accordingly, the communication path 702 may communicatively couple any number of processors 704 with one another, and allow the modules coupled to the communication path 702 to operate in a distributed computing environment. Specifically, each of the modules can operate as a node that may send and/or receive data.

The illustrated system 700 further comprises the memory component 706, which is coupled to the communication path 702 and communicatively coupled to a processor 704 of the one or more processors 704. The memory component 706 may be a non-transitory computer readable medium or non-transitory computer readable memory and may be configured as a nonvolatile computer readable medium. The memory component 706 may comprise RAM, ROM, flash memories, hard drives, or any device capable of storing machine-readable instructions such that the machine-readable instructions can be accessed and executed by the processor 704. The machine readable instructions may comprise logic or algorithm(s) written in any programming language such as, for example, machine language that may be directly executed by the processor 704, or assembly language, object-oriented programming (OOP), scripting languages, microcode, etc., that may be compiled or assembled into machine readable instructions and stored on the memory component 706. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 7, as noted above, the system 700 comprises a display, such as a graphical user interface (GUI) 724A, (i.e., which may the interface of the agent interaction apparatus/system 700 such as the agent interaction console 100 of FIG. 1 as described herein) on a screen of the device 724 for providing visual output such as, for example, information, graphical reports, messages, or a combination thereof. The display on the screen of the device 724 is coupled to the communication path 702 and communicatively coupled to the processor 704. Accordingly, the communication path 702 communicatively couples the display to other modules of the system 700. The display can comprise any medium capable of transmitting an optical output such as, for example, a cathode ray tube, light emitting diodes, a liquid crystal display, a plasma display, or the like. Additionally, it is noted that the display or the device 724 can comprise at least one of the processor 704 and the memory component 706. While the system 700 is illustrated as a single, integrated system in FIG. 7, in other embodiments, the systems can be independent systems.

The system 700 comprises the artificial intelligence module 712 configured to implement a large language model such as one or more generative pre-trained transformers 506 as described herein. The machine-learning sub-module 712A of the artificial intelligence module 712 is configured to apply machine-learning models to the artificial intelligence models to implement the large language model and provide machine-learning capabilities to a neural network, as described in greater detail further below. The interaction module 716 communicatively coupled to the artificial intelligence module 612 is configured to implement one or more process of the agent interaction processes and control schemes described herein such as with reference to at least the flow diagram 500 of FIG. 5 and/or the process 600 of FIG. 6 such as via the agent interaction console 100 of FIGS. 1-4 for an interaction between a user such as a customer and an agent viewing the agent interaction console 100 and interacting with the user while being guided by the systems and methods described herein.

The artificial intelligence module 712, the machine-learning sub-module 712A, and the interaction module 716 may be coupled to the communication path 702 and communicatively coupled to the processor 704.

Data stored and manipulated in the system 700 as described herein is utilized by the artificial intelligence module 712, which is able to leverage a cloud computing-based network configuration such as the cloud to apply Machine Learning and Artificial Intelligence. This machine learning application may create models via the machine-learning sub-module 712A that can be applied by the system 700, to make it more efficient and intelligent in execution. As an example and not a limitation, the artificial intelligence module 712 may include artificial intelligence components selected from the group consisting of an artificial intelligence engine, Bayesian inference engine, and a decision-making engine, and may have an adaptive learning engine further comprising a deep neural network learning engine.

The system 700 further includes the network interface hardware 718 for communicatively coupling the system 700 with a computer network such as network 722. The network interface hardware 718 is coupled to the communication path 702 such that the communication path 702 communicatively couples the network interface hardware 718 to other modules of the system 700. The network interface hardware 718 can be any device capable of transmitting and/or receiving data via a wireless network. Accordingly, the network interface hardware 718 can comprise a communication transceiver for sending and/or receiving data according to any wireless communication standard. For example, the network interface hardware 718 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 7, data from various applications running on device 724 can be provided from the device 724 to the system 700 via the network interface hardware 718. The device 724 can be any device having hardware (e.g., chipsets, processors, memory, etc.) for communicatively coupling with the network interface hardware 718 and a network 722. Specifically, the device 724 can comprise an input device having an antenna for communicating over one or more of the wireless computer networks described above.

The network 722 can comprise any wired and/or wireless network such as, for example, wide area networks, metropolitan area networks, the internet, an intranet, satellite networks, or the like. Accordingly, the network 722 can be utilized as a wireless access point by the device 724 to access one or more servers (e.g., a server 720). The server 720 and any additional servers generally comprise processors, memory, and chipset for delivering resources via the network 722. Resources can include providing, for example, processing, storage, software, and information from the server 720 to the system 700 via the network 722. Additionally, it is noted that the server 720 and any additional servers can share resources with one another over the network 722 such as, for example, via the wired portion of the network, the wireless portion of the network, or combinations thereof. Where used herein, “a first element, a second element, or combinations thereof” reference an “and/or” combination similar to use herein of “at least one of a first element or a second element.”

### Example Clauses

Implementation examples are described in the following numbered clauses:

Clause 1: An agent interaction method, the method comprising: obtaining streaming interaction data contemporaneously generated from an interaction with a user; determining, with a large language model, an intent expressed in the streaming interaction data; generating a prompt comprising one or more inquiries based on the intent expressed in the streaming interaction data; generating, from the streaming interaction data fed into the large language model and directed by the prompt, text corresponding to one or more responses from the user to the one or more inquiries; generating, with the large language model, at least one guidance request based on an absence of a response to, a need for clarification of, or supplemental information to request for at least one of the one or more inquiries based on the one or more responses from the user; and outputting the at least one guidance request within a guidance section of an interface communicatively coupled to an agent interaction apparatus.

Clause 2: The method of Clause 1, further comprising: based on the at least one guidance request, sending a request to the user to provide one or more multimedia data uploads related to the intent expressed in the streaming interaction data; obtaining the one or more multimedia data uploads based on the request; generating, with the large language model, one or more multimedia insights from the one or more multimedia data uploads; and outputting the one or more multimedia insights within the interface communicatively coupled to the agent interaction apparatus.

Clause 3: The method of any one of Clauses 1-2, further comprising: obtaining one or more multimedia data uploads from the user during the interaction; generating, with the large language model, one or more multimedia insights from the one or more multimedia data uploads; comparing, with the large language model, the one or more multimedia insights and the one or more responses to determine that one or more conflicts are present; and generating, with the large language model from the one or more conflicts, the at least one guidance request based on the need for clarification of the at least one of the one or more inquires to resolve the one or more conflicts.

Clause 4: The method of Clause 3, wherein generating, with the large language model, the one or more multimedia insights from the one or more multimedia data uploads, the large language model is directed by the one or more inquiries such that the one or more multimedia insights is based on at least one of the one or more inquiries.

Clause 5: The method of Clause 3, further comprising outputting, within the interface, an alert contemporaneously with the determination that the one or more conflicts are present.

Clause 6: The method of any one of Clauses 1-5, wherein the interface comprises one or more sections configured to dynamically update content displayed within each of the one or more sections during the interaction with the user based on at least one of the one or more responses from the user to the one or more inquiries or the user guidance response.

Clause 7: The method of Clause 6, wherein the one or more sections comprise a respective section for displaying at least one of: a real-time transcription of the streaming interaction data, the one or more inquiries, the one or more responses, the at least one guidance request, one or more multimedia data uploads, one or more multimedia insights based on the one or more multimedia data uploads, the user guidance response, or combinations thereof.

Clause 8: The method of any one of Clauses 1-7, further comprising: receiving a request to provide an interaction summary upon conclusion of the interaction with the user based on at least the one or more responses from the user to the one or more inquiries and the user guidance response; generating, with the large language model directed by a summary prompt, the interaction summary; and outputting the interaction summary within a summary section of the interface communicatively coupled to the agent interaction apparatus.

Clause 8: The method of any one of Clauses 1-7, further comprising: receiving a user guidance response based on the at least one guidance request; and removing the at least one guidance request from the guidance section of the interface when the user guidance response is determined, by the large language model continuously processing the streaming interaction data, to satisfy the at least one guidance request.

Clause 9: One or more apparatuses, comprising: one or more memories comprising executable instructions; and one or more processors configured to execute the executable instructions and cause the one or more apparatuses to perform a method in accordance with any one or any combination of clauses 1-8.

Clause 10: One or more apparatuses configured for wireless communications, comprising: one or more memories; and one or more processors, coupled to the one or more memories, configured to cause the one or more apparatuses to perform a method in accordance with any one or any combination of Clauses 1-9.

Clause 11: One or more apparatuses configured for wireless communications, comprising: one or more memories; and one or more processors, coupled to the one or more memories, configured to perform a method in accordance with any one or any combination of Clauses 1-9.

Clause 12: One or more apparatuses, comprising means for performing a method in accordance with any one or any combination of Clauses 1-9.

Clause 13: One or more non-transitory computer-readable media comprising executable instructions that, when executed by one or more processors of one or more apparatuses, cause the one or more apparatuses to perform a method in accordance with any one or any combination of Clauses 1-9.

Clause 14: One or more computer program products embodied on one or more computer-readable storage media comprising code for performing a method in accordance with any one or any combination of Clauses 1-9.

Clause 15: One or more systems for agent-customer interaction comprising a process and a memory storing computer-executable instructions that, when executed by the processor, cause the system to perform a method in accordance with any one or any combination of Clauses 1-9.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An agent interaction apparatus, comprising: one or more memories; and one or more processors coupled to the one or more memories storing computer-executable instructions configured to cause the agent interaction apparatus to:
obtain streaming interaction data contemporaneously generated from an interaction with a user;
determine, with a large language model, an intent expressed in the streaming interaction data;
generate a prompt comprising one or more inquiries based on the intent expressed in the streaming interaction data;
generate, from the streaming interaction data fed into the large language model and directed by the prompt, text corresponding to one or more responses from the user to the one or more inquiries;
generate, with the large language model, at least one guidance request based on an absence of a response to, a need for clarification of, or supplemental information to request for at least one of the one or more inquiries based on the one or more responses from the user; and
output the at least one guidance request within a guidance section of an interface communicatively coupled to the agent interaction apparatus.

2. The agent interaction apparatus of claim 1, wherein the computer-executable instructions further cause the agent interaction apparatus, when executed by the one or more processors, to:
based on the at least one guidance request, send a request to the user to provide one or more multimedia data uploads related to the intent expressed in the streaming interaction data;
obtain the one or more multimedia data uploads based on the request;
generate, with the large language model, one or more multimedia insights from the one or more multimedia data uploads; and
output the one or more multimedia insights within the interface communicatively coupled to the agent interaction apparatus.

3. The agent interaction apparatus of claim 1, wherein the computer-executable instructions further cause the agent interaction apparatus, when executed by the one or more processors, to:
obtain one or more multimedia data uploads from the user during the interaction;
generate, with the large language model, one or more multimedia insights from the one or more multimedia data uploads;
compare, with the large language model, the one or more multimedia insights and the one or more responses to determine that one or more conflicts are present; and
generate, with the large language model from the one or more conflicts, the at least one guidance request based on the need for clarification of the at least one of the one or more inquires to resolve the one or more conflicts.

4. The agent interaction apparatus of claim 3, wherein to generate, with the large language model, the one or more multimedia insights from the one or more multimedia data uploads, the large language model is directed by the one or more inquiries such that the one or more multimedia insights is based on at least one of the one or more inquiries.

5. The agent interaction apparatus of claim 3, wherein the computer-executable instructions further cause the agent interaction apparatus, when executed by the one or more processors, to output, within the interface, an alert contemporaneously with the determination that the one or more conflicts are present.

6. The agent interaction apparatus of claim 1, wherein the interface comprises one or more sections configured to dynamically update content displayed within each of the one or more sections during the interaction with the user based on at least one of the one or more responses from the user to the one or more inquiries or the user guidance response.

7. The agent interaction apparatus of claim 6, wherein the one or more sections comprise a respective section for displaying at least one of:
a real-time transcription of the streaming interaction data,
the one or more inquiries,
the one or more responses,
the at least one guidance request,
one or more multimedia data uploads,
one or more multimedia insights based on the one or more multimedia data uploads,
the user guidance response, or
combinations thereof.

8. The agent interaction apparatus of claim 1, wherein the computer-executable instructions further cause the agent interaction apparatus, when executed by the one or more processors, to:
receive a request to provide an interaction summary upon conclusion of the interaction with the user based on at least the one or more responses from the user to the one or more inquiries and the user guidance response;
generate, with the large language model directed by a summary prompt, the interaction summary; and
output the interaction summary within a summary section of the interface communicatively coupled to the agent interaction apparatus.

9. The agent interaction apparatus of claim 1, wherein the computer-executable instructions further cause the agent interaction apparatus, when executed by the one or more processors, to:
receive a user guidance response based on the at least one guidance request; and
remove the at least one guidance request from the guidance section of the interface when the user guidance response is determined, by the large language model continuously processing the streaming interaction data, to satisfy the at least one guidance request.

10. An agent interaction method, the method comprising:
obtaining streaming interaction data contemporaneously generated from an interaction with a user;
determining, with a large language model, an intent expressed in the streaming interaction data;
generating a prompt comprising one or more inquiries based on the intent expressed in the streaming interaction data;
generating, from the streaming interaction data fed into the large language model and directed by the prompt, text corresponding to one or more responses from the user to the one or more inquiries;
generating, with the large language model, at least one guidance request based on an absence of a response to, a need for clarification of, or supplemental information to request for at least one of the one or more inquiries based on the one or more responses from the user; and
outputting the at least one guidance request within a guidance section of an interface communicatively coupled to an agent interaction apparatus.

11. The method of claim 10, further comprising:
based on the at least one guidance request, sending a request to the user to provide one or more multimedia data uploads related to the intent expressed in the streaming interaction data;
obtaining the one or more multimedia data uploads based on the request;
generating, with the large language model, one or more multimedia insights from the one or more multimedia data uploads; and
outputting the one or more multimedia insights within the interface communicatively coupled to the agent interaction apparatus.

12. The method of claim 10, further comprising:
obtaining one or more multimedia data uploads from the user during the interaction;
generating, with the large language model, one or more multimedia insights from the one or more multimedia data uploads;
comparing, with the large language model, the one or more multimedia insights and the one or more responses to determine that one or more conflicts are present; and
generating, with the large language model from the one or more conflicts, the at least one guidance request based on the need for clarification of the at least one of the one or more inquires to resolve the one or more conflicts.

13. The method of claim 12, wherein generating, with the large language model, the one or more multimedia insights from the one or more multimedia data uploads, the large language model is directed by the one or more inquiries such that the one or more multimedia insights is based on at least one of the one or more inquiries.

14. The method of claim 12, further comprising outputting, within the interface, an alert contemporaneously with the determination that the one or more conflicts are present.

15. The method of claim 10, wherein the interface comprises one or more sections configured to dynamically update content displayed within each of the one or more sections during the interaction with the user based on at least one of the one or more responses from the user to the one or more inquiries or the user guidance response.

16. The method of claim 15, wherein the one or more sections comprise a respective section for displaying at least one of:
a real-time transcription of the streaming interaction data,
the one or more inquiries,
the one or more responses,
the at least one guidance request,
one or more multimedia data uploads,
one or more multimedia insights based on the one or more multimedia data uploads,
the user guidance response, or
combinations thereof.

17. The method of claim 10, further comprising:
receiving a request to provide an interaction summary upon conclusion of the interaction with the user based on at least the one or more responses from the user to the one or more inquiries and the user guidance response;
generating, with the large language model directed by a summary prompt, the interaction summary; and
outputting the interaction summary within a summary section of the interface communicatively coupled to the agent interaction apparatus.

18. An agent interaction apparatus, comprising: one or more memories; and one or more processors coupled to the one or more memories storing computer-executable instructions configured to cause the agent interaction apparatus to:
obtain streaming interaction data contemporaneously generated from an interaction with a user;
determine, with a large language model, an intent expressed in the streaming interaction data;
generate a prompt comprising one or more inquiries based on the intent expressed in the streaming interaction data;
generate, from the streaming interaction data fed into the large language model and directed by the prompt, text corresponding to one or more responses from the user to the one or more inquiries;
generate, with the large language model, at least one guidance request based on an absence of a response to, a need for clarification of, or supplemental information to request for at least one of the one or more inquiries based on the one or more responses from the user;
output the at least one guidance request within a guidance section of an interface communicatively coupled to the agent interaction apparatus;
based on the at least one guidance request, send a request to the user to provide one or more multimedia data uploads related to the intent expressed in the streaming interaction data; and
obtain the one or more multimedia data uploads based on the request.

19. The agent interaction apparatus of claim 18, wherein the computer-executable instructions further cause the agent interaction apparatus, when executed by the one or more processors, to:
generate, with the large language model, one or more multimedia insights from the one or more multimedia data uploads; and
output the one or more multimedia insights within the interface communicatively coupled to the agent interaction apparatus.

20. The agent interaction apparatus of claim 18, wherein the computer-executable instructions further cause the agent interaction apparatus, when executed by the one or more processors, to:
generate, with the large language model, one or more multimedia insights from the one or more multimedia data uploads;
compare, with the large language model, the one or more multimedia insights and the one or more responses to determine that one or more conflicts are present; and
generate, with the large language model from the one or more conflicts, the at least one guidance request based on the need for clarification of the at least one of the one or more inquires to resolve the one or more conflicts.
